(19) United States
(12) Patent Application Publication
(10) Pub. No.: US 2011/0260008 A1
(43) Pub. Date: Oct. 27, 2011

(54) Fluid flow control device for an aerofoil

(75) Inventor: John Jaycott Smith, Cinderford (GB)

(73) Assignee: AERODYNAMIC RESEARCH INNOVATIONS HOLDINGS, LTD.

(21) Appl. No.: 13/066,736

(22) Filed: Apr. 22, 2011

(30) Foreign Application Priority Data
Apr. 27, 2010 (GB) GB 1006979.7

(51) Int. Cl. B64C 23/06; B64C 3/58; F01D 5/18

(52) U.S. Cl. 244/199.4; 416/232

(57) ABSTRACT

A fluid flow control device for an aerofoil comprises an aerofoil-tip body of aerofoil shape, coupling apparatus adapted to couple one end of the body to an aerofoil, and a passive tip blowing assembly. The passive tip blowing assembly is provided at the other end of the aerofoil-tip and comprises a housing defining a fluid chamber and a vane of aerofoil shape. The fluid chamber extends along part of the chord-length of the body and has a fluid inlet and a fluid outlet. The vane is arranged along the chord of the aerofoil-tip, with its leading edge at the inlet and its trailing edge at the outlet. The aerofoil section of the aerofoil-tip has a higher camber than that of the aerofoil, which turns fluid flow across the low pressure side of the aerofoil towards the aerofoil-tip, so that the fluid flow mirrors the fluid flow across the high pressure side of the aerofoil.

### CLAIM OF PRIORITY

This application claims the benefit of priority under 35 U.S.C. §119 of UK Patent Application Serial No. GB 1006979.7, filed on Apr. 27, 2010, which Application is incorporated by reference herein.

### FIELD

The invention relates to a fluid flow control device for an aerofoil, an aerofoil comprising the fluid flow control device, an aircraft wing comprising the fluid flow control device, an aircraft comprising the fluid flow control device, a turbine blade comprising the fluid flow control device and a wind turbine comprising the fluid flow control device.

### BACKGROUND ART

As a result of the pressure differential between the high and low pressure surfaces of a wing, airflow from the high pressure surface area migrates to the low pressure surface around the end (wingtip) of the wing.

The consequence of this is that the airflow over the wing is modified, in that the migration of the airflow across the high pressure surface around the wingtip to the low pressure surface results in a spanwise flow (that is, back and outboard on the underside of the wing). Conversely this airflow migration from the lower wing to the upper wing results in the airflow over the low pressure surface being modified to a backward and inward direction. The result of these now diverging/converging airflows when they meet at the wing's trailing edge is to create vortices, which have an outer boundary at the wingtips (where the vortex energy is greatest), and persist along the trailing edge of the wing in the direction of the aircraft's fuselage.

The effect of trailing vortices corresponding to positive lift is to induce a downward component of velocity at and behind the wing. This downward component is called downwash. The magnitude of the downwash at any section along the span is equal to the sum of the effects of all the trailing vortices along the entire span. The effect of the downwash is to change the relative direction of the airstream over the section. The rotation of the flow effectively reduces the angle of attack of the wing. The downwash is proportional to the lift coefficient and the effect of the trailing vortices is to reduce the slope of the lift curve. The rotation of the flow also causes a corresponding rotation of the lift vector to produce a drag component in the direction of motion. This component is called the “induced drag”.

Induced drag is a consequence of the presence of the wingtip vortices, which in turn are produced by the difference in pressure between the lower and upper wing surfaces. Reducing the strength of the wingtip vortices, diffusing them, and displacing them outboard will reduce the downwash on the wing at a given angle of attack, thereby resulting in an increase in lift and a decrease in induced drag. Experiments have shown that spanwise blowing from the wingtip displaces and diffuses the wingtip vortex. Spanwise wingtip blowing thus has the potential to improve the wing aerodynamic efficiency.

There have been various proposals for combating induced drag. In high performance sailplanes and in long-range airliners, high aspect ratio (AR) wings are used (as induced drag is inversely proportional to aspect ratio); unfortunately, the design of high aspect ratio wings with sufficient structural strength is difficult. It also reduces the manoeuvrability of the associated aircraft, as well as increasing airframe weight, manufacturing cost, and profile drag.

Also developed in aircraft is the use of (blended) winglets—small aerofoil section members extending upwardly and outwardly from the tips of the wing. The purpose of these winglets is to control the flow of air from the “higher pressure” first (lower wing) surface to the second (upper wing) “lower pressure” surface and so reduce the formation of wingtip vortices, ergo reducing induced drag. It should be noted that whereas blended winglets may provide some reduction in the induced drag created by wingtip vortices, it does not eliminate the trailing vortex wake which is in part created from the diverging/converging—lower wing/upper wing—airflows at the wing trailing edge. It is a problem with such winglets that, due to their reduced length, they are always of smaller length than the radius of the vortices produced at the wingtip, given that when the aircraft is climbing at a higher angle of attack (than when in straight and level flight in the cruise) it produces a greater vortex diameter. It is due to the winglets mechanical restriction, of being manufactured to a specific length, that they are designed for optimum performance at only one phase of flight—usually the cruise phase. Accordingly, such winglets do not give optimum performance throughout the flight envelope. Further, since such winglets are subject to dynamic and lateral flow forces, the winglet produces tension and/or torsion stresses in the associated wing section(s), so requiring strengthening of the wing/wing spar to avoid mechanical failure.

### SUMMARY

A first aspect of the invention provides a fluid flow control device for an aerofoil. The device comprises an aerofoil-tip body of aerofoil shape having a low pressure side and a high pressure side. The device also includes a coupling apparatus adapted to couple one end of the aerofoil-tip body to a distal end of an aerofoil. The device also has a passive tip blowing assembly provided at the other end of the aerofoil-tip body. The assembly comprises a housing defining a fluid chamber and a vane of aerofoil shape provided within the fluid chamber. The fluid chamber extends along part of the chord-length of the aerofoil-tip body and has a fluid inlet at the high pressure side and a fluid outlet at the low pressure side. The vane is arranged along the chord of the aerofoil-tip body and with its leading edge generally at the inlet and its trailing edge generally at the outlet, such that a fluid passage extending to the fluid outlet is defined on each side of the vane.

The term aerofoil (“airfoil” in American English) is used herein to mean an aerofoil-shaped body which under relative movement through a fluid produces lift and includes but is not limited to a wing of aerofoil shape, a blade of aerofoil shape (such as a wind turbine blade, a helicopter blade, a marine underwater turbine blade, a propeller blade or an impeller blade), a hydrofoil and aerofoil shaped parts found on motor vehicles (such as racing cars).

When fluid is flowing across the device, the passive tip blowing assembly creates a fluid stream (jet efflux) directed outwards, upwards and rearwards relative to the aerofoil-tip body. The vane improves the amount of acceleration applied to the fluid flow through the passive tip blowing assembly. The resulting jet efflux blocks and entrains circulatory fluid migrating from the high pressure side to the low pressure side of the aerofoil-tip body in an aft flowing irrotational line and so prevents the formation and shedding of vortices at the trailing edge of the aerofoil-tip body. The result of this “blocking” of the circulatory fluid flow across the aerofoil-tip body means that the fluid flow across the low pressure surface of an aerofoil to which the device is coupled is unmodified by the circulatory fluid flow and thus flows in a straight fore-aft line along the low pressure side of the aerofoil. The fluid flow across the low pressure side of the aerofoil is still at a convergent angle with the fluid flow across the high pressure side of the aerofoil (which is “back and out”), which results in vortices of weaker strength than in prior art systems forming and shedding at the trailing edge of the aerofoil. The device thus reduces the amount of induced drag on an aerofoil to which it is coupled.

The jet efflux blocks and entrains aerofoil-tip rotational fluid flow into an aft irrotational thrust line, thereby reducing induced drag. The aft irrotational thrust line also provides a forward thrust (“bootstrap” effect) from the jet efflux. The jet efflux provides a negative lift force which cancels the lifting property of the device itself, thus negating the requirement for aerofoil spar strengthening of the coupling between the aerofoil-tip body and a aerofoil, as is required by prior art ‘blended winglets’ as used on certain airliners. The device causes the jet efflux range to be moved downstream up to 50% of the tip chord.

The device may reduce total induced drag by harnessing the negative energy created by induced drag, not only at the aerofoil-tip but inboard along the trailing edge of the aerofoil, and may cancel the effect of induced drag in its entirety.

In an embodiment, the vane is of symmetrical faired aerofoil shape In an embodiment, the vane is of substantially the same aerofoil shape as the aerofoil-tip body.

In an embodiment, the vane is of substantially symmetric aerofoil shape and comprises a reduced-thickness section. The reduced-thickness section may enable an improved tolerance of the vane to frictional drag of fluid flow through the passive tip blowing assembly. The reduced-thickness section offers a reduced cross-sectional area of the vane to fluid flow and thus may further enable an increase in fluid flow speed and hence an increased speed of the egress jet efflux. This may further improve the effectiveness of the fluid flow control device in entraining high to low pressure migrating fluid flow through the passive tip blowing assembly.

In an embodiment, the reduced-thickness section has a generally waisted sectional shape. This may reduce fluid flow turbulence across the vane. This may further reduce drag and hence may increase the fluid flow speed across the vane and increase the speed of the egress jet efflux.

In an embodiment, the reduced-thickness section is provided between a first position on the vane chord located at generally one quarter along the chord length from the leading edge of the vane and a second position on the vane chord located generally 90 percent along the chord length from the leading edge, the camber of the vane at the first position being greater than the camber of the vane at the second position.

In an embodiment, the trailing edge of the vane extends beyond the fluid outlet. In an embodiment, approximately 10% of the chord length of the vane at its trailing edge extends beyond the fluid outlet. In an embodiment, the leading edge of the vane is located approximately at a position approximately 10% along the length of the fluid chamber from the fluid inlet.

In an embodiment, the passive tip blowing assembly is arranged to form a fluid stream (jet efflux) directed at an angle of between 20° and 40° to a plane normal to the plane of an aerofoil and normal to the length of an aerofoil to which the device is attached. In an embodiment, the angle is 30°.

In an embodiment, the passive tip blowing assembly is arranged to form a fluid stream having an effective length at least 1.5 times the maximum diameter of vortices that would be generated at the end of the device in the absence of the fluid stream.

In an embodiment, the fluid outlet is smaller than the fluid inlet such that the fluid chamber is convergent in the direction of fluid flow. This may further accelerate the fluid flow.

In an embodiment, the cross-sectional size of the fluid chamber reduces substantially linearly along its length by a ratio of at least 3:1, and preferably 4:1.

In an embodiment, the vane is arranged within the fluid chamber such that there is a constant separation between each surface of the vane and a respective wall of the fluid chamber.

In an embodiment, the vane has a serrated leading edge. This may provide a noise cancelling effect. In an embodiment, all leading edges, being edges on which fluid flow is incident, are provided with a serrated edge to provide noise cancelling.

In an embodiment, the housing comprises a concave shaped outer skin. In an embodiment, the outer skin is concave along the direction of the chord of the aerofoil-tip body and is additionally concave in the perpendicular direction across the outer skin.

In an embodiment, the fluid inlet is generally trapezoidal in shape. This may encourage the flow of fluid from the high pressure side of the aerofoil-tip body into the fluid chamber.

In an embodiment, the device further comprises a NACA scoop provided on the high pressure side of the aerofoil-tip body between the leading edge of the aerofoil-tip body and the fluid inlet. The NACA scoop may be contoured into the forward opening of the fluid inlet.

In an embodiment, the aerofoil-tip body has an aerofoil shape which is different to the aerofoil shape of an aerofoil to which the fluid flow control device is to be coupled. This may provide an improved lift polar to the aerofoil-tip body, and the fluid pressure of fluid flowing over the low pressure side of the aerofoil-tip body is thereby made lower than the fluid pressure of fluid flowing over the low pressure side of an aerofoil to which the device is coupled. The fluid flow over the low pressure side of the aerofoil may thereby be made to turn towards the device. The fluid flow over the low pressure side of the aerofoil may thus be made to substantially mirror the fluid flow over the high pressure side of the aerofoil. Providing substantially mirrored fluid flows across the low and high pressure sides of the aerofoil may result in a reduction or prevention of vortices being shed from the trailing edge of the aerofoil. The device may thus harness the negative energy created by induced drag both at the aerofoil-tip and inboard along the trailing edge of an aerofoil, and may reduce the effect of induced drag.

In an embodiment, the aerofoil-tip body has an aerofoil shape of a different upper camber to the upper camber of the aerofoil shape of an aerofoil to which the fluid flow control device is to be coupled.

In an embodiment, the aerofoil-tip body has an aerofoil shape of a higher upper camber to the upper camber of the aerofoil shape of an aerofoil to which the fluid flow control device is to be coupled. The fluid flow over the low pressure side of the aerofoil may thus be made to exactly mirror the fluid flow over the high pressure side of the aerofoil. Providing exactly mirrored fluid flows across the low and high pressure sides of the aerofoil may prevent vortices being shed from the trailing edge of the aerofoil, thereby cancelling the vortex sheet which normally emanates from the trailing edge of an aerofoil. The device may thus harness the negative energy created by induced drag both at the aerofoil-tip and inboard along the trailing edge of an aerofoil, and may cancel the effect of induced drag in its entirety.

In an embodiment, the aerofoil-tip body has an aerofoil shape of a different NACA number than to the NACA number of the aerofoil shape of an aerofoil to which the fluid flow control device is to be coupled.

A second aspect of the invention provides an aerofoil having a distal end, the aerofoil having a fluid flow control device as described above.

A third aspect of the invention provides an aircraft wing comprising a root portion for connection to the body of an aircraft, a central portion and a distal end portion and having a fluid flow control device as described above provided at the distal end of the distal end portion.

A fourth aspect of the invention provides an aircraft comprising an aircraft wing comprising a root portion for connection to the body of an aircraft, a central portion and a distal end portion and having a fluid flow control device as described above provided at the distal end of the distal end portion.

An aircraft comprising the fluid flow control device may have reduced fuel consumption with correspondingly reduced carbon emissions. This may provide lower airport noise levels from a reduced dB(A) footprint on take-off. The absence of induced drag may provide a boost in climb performance, higher cruise altitude and higher cruise speed. The fluid flow control device may also provide removal of hazardous wake vortices that can cause problems on take-off and landing for an aircraft following another aircraft that has just taken off or landed. The fluid flow control device may also provide lower stall speeds, lower take-off speeds and lower target threshold speeds on landing with consequently reduced touch-down speeds. This may reduce runway extension requirements, allowing operations from existing shorter runways. This may result in reduced maintenance costs with normal check cycles being extended, including less wear on tyres and brakes and reverse thrust requirements. As a result of the decreased fuel consumption, less fuel will need to be uplifted for any given trip thus allowing the payload to be increased (subject to zero fuel weight requirements not being exceeded).

A fifth aspect of the invention provides a turbine blade comprising a root portion for connection to a turbine body, a central portion and a distal end portion and having a fluid flow control device as described above provided at the distal end of the distal end portion.

A sixth aspect of the invention provides a wind turbine comprising a turbine blade comprising a root portion for connection to a turbine body, a central portion and a distal end portion and having a fluid flow control device as described above provided at the distal end of the distal end portion.

A wind turbine comprising the fluid flow control device may have reduced noise levels during operation. The absence of induced drag may provide an increase in power generation performance and operation may be achievable at lower wind speeds. The fluid flow control device may also provide lower stall speeds and lower starting speeds.

Additional features and advantages of the disclosure are set forth in the detailed description that follows, and in part will be readily apparent to those skilled in the art from that description or recognized by practicing the embodiments as described herein, including the detailed description which follows, the claims, as well as the appended drawings. The claims constitute part of this specification and are hereby incorporated into the detailed description by reference.

It is to be understood that both the foregoing general description and the following detailed description presented below are intended to provide an overview or framework for understanding the nature and character of the disclosure as it is claimed. The accompanying drawings are included to provide a further understanding of the disclosure, and are incorporated into and constitute a part of this specification. The drawings illustrate various embodiments of the disclosure, and together with the description serve to explain the principles and operations of the disclosure.

### BRIEF DESCRIPTION OF THE DRAWINGS

Embodiments of the invention will now be described in detail, by way of example only, with reference to the accompanying drawings, in which:

FIG. 1 is a schematic plan view (a) from above and (b) from below of an aircraft wing showing schematically the flow of air over the wing;

FIG. 2 is a diagrammatic representation of an end of a wing of an aircraft and a fluid flow control device according to a first embodiment of the invention;

FIG. 3 is a diagrammatic representation of the fluid flow control device of FIG. 2;

FIG. 4 is a diagrammatic plan view from above of the fluid flow control device of FIGS. 2 & 3, shown coupled fitted to an aerofoil;

FIG. 5 is a diagrammatic plan view from below of the fluid flow control device of FIGS. 2 & 3, shown coupled fitted to an aerofoil;

FIG. 6 is a diagrammatic sectional view along line A-A of FIG. 4;

FIG. 7 is a diagrammatic end view of the fluid flow control device of FIG. 2 showing the jet efflux;

FIG. 8 is a plan view (a) from above and (b) from below of an aircraft wing comprising the fluid flow device of FIG. 2 showing the fluid flow pattern over the wing;

FIG. 9 is a diagrammatic representation of a fluid flow control device according to a second embodiment of the invention;

FIG. 10 is a sectional view of the vane of FIG. 9;

FIG. 11 is a diagrammatic plan view from above of an aerofoil according to a third embodiment of the invention;

FIG. 12 is a diagrammatic plan view from above of an aircraft wing according to a fourth embodiment of the invention;

FIG. 13 is a diagrammatic representation of an aircraft according to a fifth embodiment of the invention;

FIG. 14 is a diagrammatic plan view from above of a turbine blade according to a sixth embodiment of the invention; and

FIG. 15 is a diagrammatic representation of a wind turbine according to a seventh embodiment of the invention.

### DETAILED DESCRIPTION

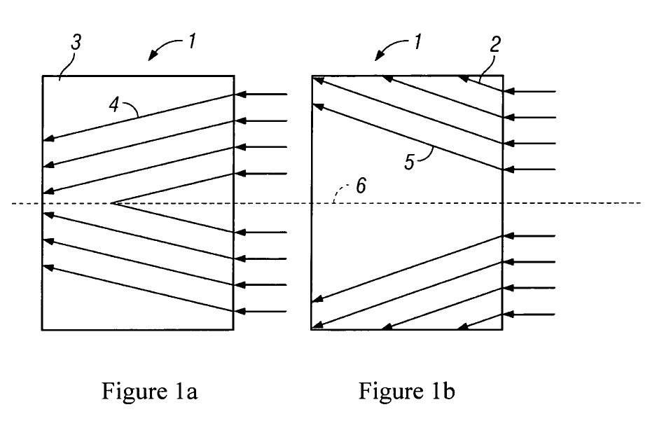

Referring to FIG. 1, a prior art wing 1 typically has an upper (low pressure) surface 3 and a lower (high pressure) surface 2. The wing 1 is disposed to either side of a fuselage indicated by centre-line 6. The wing 1 has an aerofoil section.

As is well known, when a wing 1 is in motion, the fluid flow over and under the wing 1 produces a relatively lower pressure over the upper surface 3 (referred to herein as the low pressure side) of the wing 1 and a relatively higher pressure over the lower surface 2 (referred to herein as the high pressure side) of the wing 1. As a result of this pressure difference, air from the higher pressure region on the lower wing surface 2 tends to seek the lower pressure area on the upper surface 3. On a standard aircraft wing lower wing (high pressure) spanwise flow migrating around the wingtip modifies the upper wing (low pressure) airflow to a back and inward direction. As a result, the streamlines 4 of the fluid flow across the upper surface 3 tend to converge towards the fuselage centre line 6 while the streamlines 5 of the fluid flow across the lower surface 2 tend to diverge from the fuselage centre line 6, as shown in FIG. 1. This convergent/divergent flow pattern produces vortices that are shed from the trailing edge of the wing 3, that is “at” and “inboard” of the end of the wing 1. This spillage of air from the lower surface 2 to the upper surface 3 sets up a vortex, where wingtip vortices together with trailing edge vortices shed from the wing 1 describing a vortex sheet behind the wing 1 of up to sixteen times the wingspan of the aircraft in question. The effect of this fluid flow is to generate an induced drag, which is inversely proportional to the square of the airspeed and inversely proportional to the aspect ratio.

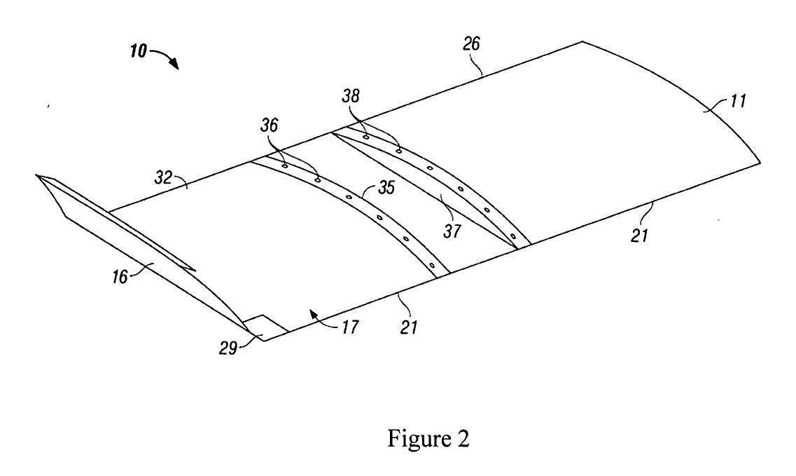

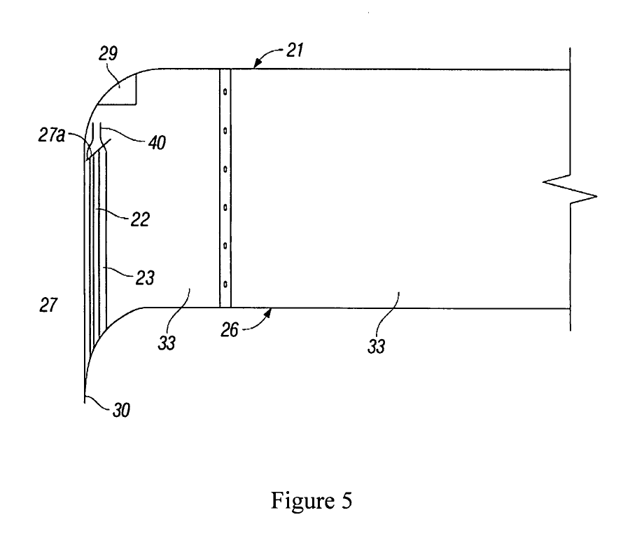

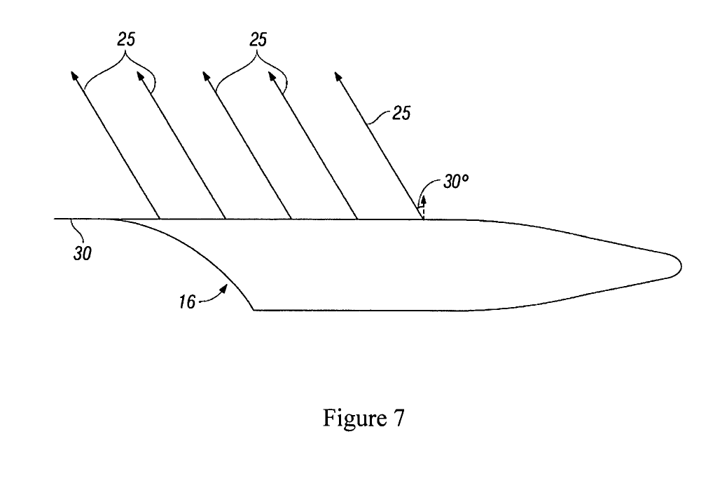

Referring to FIGS. 2 to 7, a first embodiment of the invention provides a fluid flow control device 10 for an aerofoil 11 comprising an aerofoil-tip body 17, coupling apparatus 36, 38 and a passive tip blowing assembly 16.

The aerofoil-tip body 17 is of aerofoil shape having a low pressure side 32 and a high pressure side 33. The coupling apparatus 36, 38 is adapted to couple one end 35 of the aerofoil-tip body 17 to a distal end 37 of an aerofoil 11.

The passive tip blowing assembly 16 is provided at the other end of the aerofoil-tip body 17. The assembly 16 comprises a housing 18 defining a fluid chamber 23 and a vane 22 of aerofoil shape provided within the fluid chamber. The fluid chamber 23 extends along part of the chord-length of the aerofoil-tip body 17 and has a fluid inlet 27 at the high pressure side 33 and a fluid outlet 28 at the low pressure side 32. The vane 22 is arranged along the chord of the aerofoil-tip body, within the fluid chamber 23, with its leading edge 22a generally at the inlet 27 and its trailing edge 22b generally at the outlet 28. The vane 22 and the housing 18 together define fluid passages 23a extending to the fluid outlet 28 on each side of the vane.

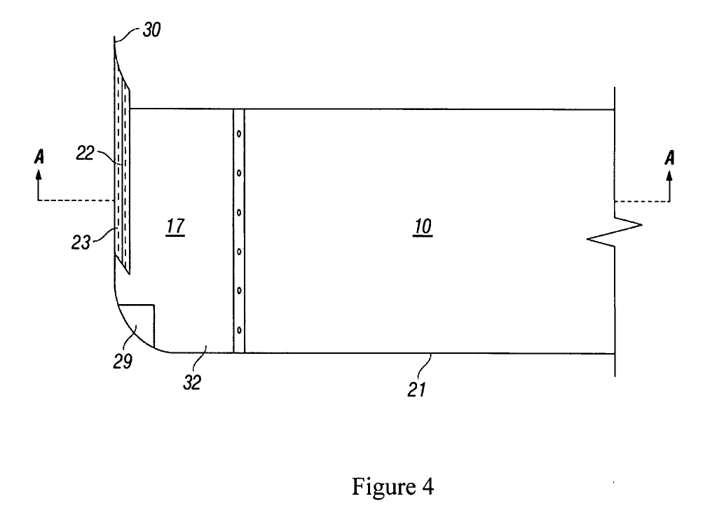

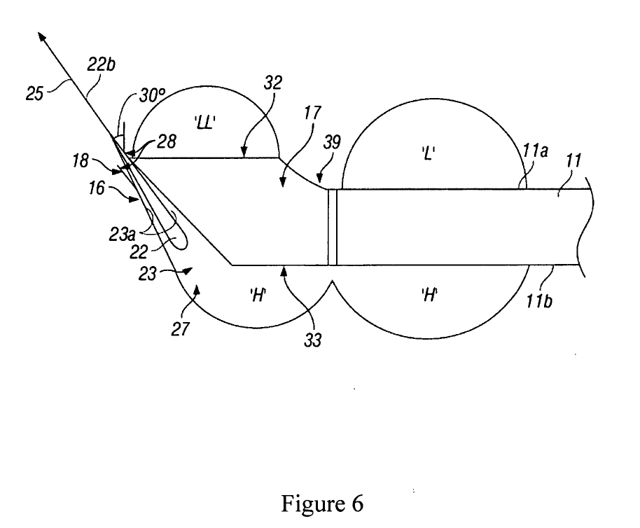

The passive tip blowing assembly 16 comprises a housing 18 that may, for example, be formed of a carbon fibre composite or plastics material. The housing 18 includes an inboard wall 19 and a spaced outboard wall 20. The inboard wall 19 and the outboard wall 20, commencing at the lower wing fluid flow inlet area, are generally rectangular (although concave in the direction of the fuselage) in shape and each has sides that converge towards a leading edge 21 (see FIG. 4) of the aerofoil-tip 17. As seen in FIG. 6, the inboard wall 19 and the outboard wall 20 converge towards each other in an upward and rearward direction.

The vane 22 is arranged parallel to the inner and outer wall (19 & 20), along the chord of the aerofoil-tip body, giving a set spacing in the y-axis and extending from the pressure side 33 to a percentage above the low pressure side 32 and converging from the high pressure side 33 to the low pressure side 32. The convergence may be at least 4:1. The upper egress point (shape) of the assembly 16 may resemble a scaled down version of the aerofoil-tip aerofoil section.

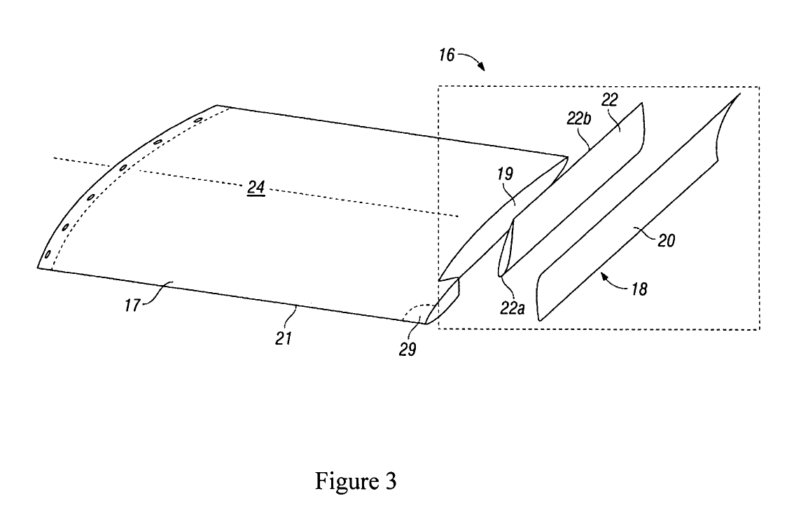

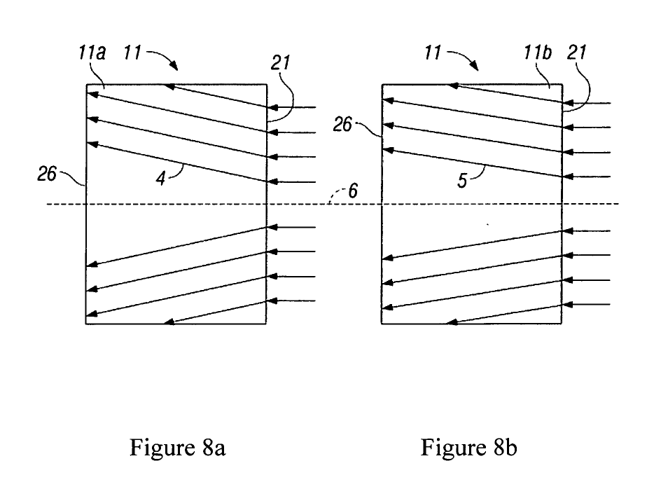

As seen in FIG. 3, the vane 22 is incurred at an angle to a plane including the aerofoil axis 24 and of the aerofoil-tip 17. This angle may vary dependant upon aerofoil design. In addition, as seen in FIG. 6, the axis 25 of passage 23 is inclined outwardly relative to a plane normal to the aerofoil axis 24 and normal to the plane of the aerofoil 11. This inclination may be between 30° and 70° and is preferably 30° measured from the vertical y-axis (being normal to the aerofoil axis 24 and the plane of the aerofoil 11). Further, as seen in FIG. 8, passage axis 25 is also inclined relative to a plane including in the aerofoil axis 24 and normal to the plane of aerofoil 11. This inclination may be between 40° and 60° and is preferably 30°. The length of the passage 23 is equal to the distance from the leading edge 21 of the aerofoil-tip to its trailing edge 26.

The forward part of the housing 18 may contain lights 29. In addition, the trailing edge of the housing 18 may be provided with a stinger fairing 30 extending beyond the trailing edge 26. This stinger fairing may in turn house a static wick for electrical discharge purposes.

The aerofoil-tip 17 is of aerofoil shape with the low pressure side 32 and the high pressure side 33 extending between a leading edge 21 and a trailing edge 26. The assembly 16 is mounted at one end of the aerofoil-tip 17 and the other end of the assembly 16 is provided with an open end 35 that, in use, is a mating fit with an open end of an aerofoil 11 with which the device 10 is to be used. The profile of the aerofoil-tip 17 is matched to the profile of the associated aerofoil 11. This will be described in more detail below.

The high pressure side 33 of the aerofoil-tip 17 leads to the inlet 27 to the fluid chamber 23. A NACA scoop 39a is provided on the high pressure side 33 of the aerofoil-tip, between the leading edge 21 and the forward edge 27a of the fluid inlet 27. In order to prevent separation of fluid from these surfaces they may employ trip strips for inducing turbulence in the boundary layer.

In use, the device 10 is fitted to the distal end of an aerofoil 11. The distal end of the aerofoil 11 is provided with a peripheral recess 37 around the cross-section of the aerofoil 11 provided with fixing holes 38. The open end 35 of the aerofoil-tip 17 fits over the recess 37 with the fixing holes 36 in the aerofoil-tip 17 aligned with the fixing holes 38 around the recess. Fixing means such as screws or rivets are then used to connect the parts together.

For use with an aerofoil 11, the aerofoil-tip 17 is provided with an aerofoil section that has an improved lift polar. For example, an aerofoil with a NACA aerofoil 2412 may be fitted with an aerofoil-tip having a NACA 3518 aerofoil, or a NACA aerofoil 4415 may be fitted with a NACA 6415 aerofoil aerofoil-tip. The effect of this is that the aerofoil-tip 17 has an increased camber. The result of this, as seen in FIG. 6, is to produce over the low pressure surface 32 of the aerofoil-tip 17 an area of pressure that is lower than the pressure over the low pressure surface 11a of the aerofoil 11. Accordingly, the aerofoil-tip 17 has a zone 39 in which the profile of the aerofoil-tip 17 blends into the profile of the aerofoil 11.

In fluid flow, as described above, the aerofoil section of an aerofoil 11 in the form of an aircraft wing 1 produces a greater pressure on the lower wing surface 2 than on the upper wing surface 3 and the fluid flow over the lower surface 2 tends to migrate towards the lower pressure area on the upper surface 3 in an outward flow of the kind shown in FIG. 1. The fluid will enter the inlet 27; the radius of the inlet may be provided with a trip strip. The trapezoidal shape of the inlet 27, with its angled forward edge 27a, as seen best in FIG. 4 encourages this flow. The fluid enters the passages 23a around the vane 22, and is accelerated as the fluid chamber 23 converges. The vane 22 is critical in obtaining the required acceleration through the passive tip blowing assembly 16. There thus emerges from the outlets 28 a jet of fluid that forms a sheet or wall of fast moving fluid. As a result of the orientation of the passage 23, this sheet of fluid is directed upwardly, outwardly, and rearwardly (relative to the leading edge 21) of the aerofoil-tip 17, as orientated in FIG. 4.

The fluid flow through the passages 23 weakens the general spillage of air around the aerofoil-tip 17 from the lower surface 2 of the wing 1 to the upper surface 3 of the wing, since some of the fluid passes through the passages 23a to form the fluid stream emerging from the outlets 28. Such fluid as does pass around the end of the aerofoil-tip 17 will merge with the sheet of air emerging from the outlets 28 to produce a cumulative rearwardly directed but non-vortex containing fluid flow.

In addition, the aerofoil section given to the aerofoil-tip 17 produces at the aerofoil-tip 17 an area of pressure that is lower than the pressure on the upper surface 11a of the aerofoil 11, as shown in FIG. 6. The effect of this is to change (turn) the fluid flow over the upper surface 11a of the aerofoil from that shown in FIG. 1 to that shown in FIG. 8. The fluid flow over the upper surface 11a of the aerofoil 11 is now away from the centre-line 6 (that is back and out). In addition, the flow over the lower surface 11b of the aerofoil 11 corresponds to the fluid flow over the upper surface 11a. Accordingly, the fluid flow over both surfaces is substantially the same, thus cancelling the vortex sheet that normally emanates from the trailing edge 26.

It will be appreciated that the sheet or jet of fluid emerging from the outlet 28 will have a velocity related to the velocity of the fluid over the aerofoil 11 and the aerofoil-tip 17. Accordingly, the velocity and length of the sheet of fluid will automatically vary in accordance with changes in the angle of attack and true speed of the aerofoil 11. Thus, at varying angles of attack and speed, the velocity and length of the sheet or jet of fluid will be modified in accordance with pressure differentials incurred on the aerofoil in question. In the case of a aerofoil comprising an aircraft wing, the varying pressure differentials thus effectively “tune” the fluid flow control device 10 to provide a sheet or jet of air of optimum length during different phases of flight.

In this regard, it is known that the mean diameter of the vortex at an aerofoil-tip is approximately 0.171 of the wingspan for a given aircraft. It has been found that, during flight testing of the fluid flow control device 10, the length of the air sheet or jet produced by the device exceeds this by a factor of 1.5 at any given angle of attack.

The air emerging from the passages 23 produces a downward resultant force that is equal to the lift produced by the aerofoil-tip 17. There is thus no torsion or tension stress on the device and its attachment points. This is why the device 10 can be a sleeve-fit onto an aerofoil (wing) 11 and attached by machine screws. No additional wing spar attachment strengthening is required as the device, manufactured from carbon fibre composite material is manufactured to a similar weight and centre-of-gravity limit as the wingtip it replaces.

A fluid flow control device 10 as described above has been fitted to a Cessna 172SP aircraft. Flight trials, conducted under EASA/CAA approval, have been operated in clear air over a number of routes at altitudes up to 12,500 feet. In all cases the test flights were measured against identical profiles flown by a non-modified identical aircraft. The modified aircraft flew the same test profiles, high and low level, and recorded an average 13% improvement in performance, which translates to a 13% reduction in fuel burn when operated at the same airspeeds as the standard identical aircraft. The test version of the fluid flow control device 10 was manufactured from glass-fibre however the fluid flow control device 10 will be constructed from carbon fibre composite material and glass fibre, and have an anticipated performance increase of greater than the 13% of the glass fibre test device. They will be flight tested in 2010 as part of an EASA/FAA STC (Supplemental Type Certificate) programme on a Cessna 172SP and a Cessna 208B aircraft.

It is believed that aircraft fitted with the fluid flow control device 10 will, therefore, have reduced fuel consumption with correspondingly reduced carbon emissions. There will be lower airport noise levels from a reduced dB(A) footprint on take-off. In addition, the absence of induced drag will provide a boost in climb performance, higher cruise altitude and higher cruise speed. There will also be the removal of hazardous wake vortices that can cause problems on take-off and landing for an aircraft following another aircraft that has just taken off or landed. The device 10 will also provide lower stall speeds, lower take-off speeds and lower target threshold speeds on landing with consequently reduced touch-down speeds. This will reduce runway extension requirements, allowing operations from existing shorter runways. As a result, there will be reduced maintenance costs with normal check cycles being extended, including less wear on tyres and brakes and reverse thrust requirements. In view of the decreased fuel consumption, less fuel will need to be uplifted for any given trip thus allowing the payload to be increased (subject to zero fuel weight requirements not being exceeded). Further, the fluid flow control device 10 is simple and relatively inexpensive to manufacture, and equally simple and inexpensive to fit.

The fluid flow control device 10 described above may be used with a wide variety of aerofoils, including an aircraft wing of aerofoil shape, helicopter blades, a blade of aerofoil shape (such as a wind turbine blade, a marine underwater turbine blade, a propeller blade or an impeller blade), a hydrofoil and aerofoil shaped parts found on motor vehicles (such as racing cars).

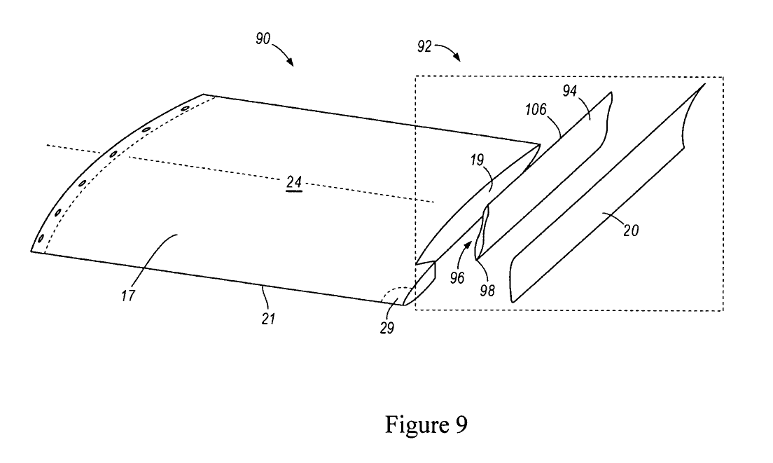

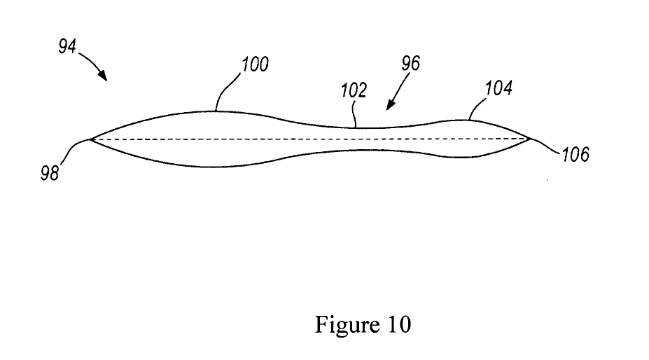

A second embodiment of the invention provides a fluid flow control device 90 for an aerofoil 11 as shown in FIGS. 9 and 10. The fluid flow control device 90 is similar to the fluid flow control device 10 of the first embodiment, with the following modifications.

In this embodiment, the passive tip blowing assembly 92 comprises a vane 94 of substantially symmetric aerofoil shape. The vane 94 comprises a reduced-thickness section 96 having a generally waisted sectional shape. The reduced-thickness section 96 extends along substantially the whole length of the vane 94.

As shown in FIG. 10, the thickness of the reduced-thickness section 96 smoothly reduces in a direction along the chord from a maximum thickness at a highest camber position 100 to a minimum thickness at a turning point 102. The reduced-thickness section then smoothly increases in a direction along the chord from the turning point 102 to a second camber position 104. In this example, the highest camber position 100 is located at 25.5% from the leading edge 98 along the chord and the second camber position is located at 90.5% from the leading edge 98 along the chord. The thickness of the vane 94 at the turning point 102 is 61.5% of the thickness of the vane at the highest camber position 100. In this example, the thickness of the vane 94 at the second camber position 104 is 77% of the thickness of the vane at the highest camber position 100. It will be appreciated by the skilled man that other relative thicknesses may be used.

The reduced-thickness section 96 improves the tolerance of the vane 94 to frictional drag of fluid flow through the passive tip blowing assembly 92 by offering a reduced cross-sectional area of the vane to the fluid flow. This further enables an increase in fluid flow speed and hence an increased speed of the egress jet efflux. This improves the effectiveness of the fluid flow control device in entraining high to low pressure migrating fluid flow through the passive tip blowing assembly 92. The generally waisted shape of the reduced-thickness section 96 reduces fluid flow turbulence across the vane 94. This further reduces drag and hence increases the fluid flow speed across the vane and increases the speed of the egress jet efflux.

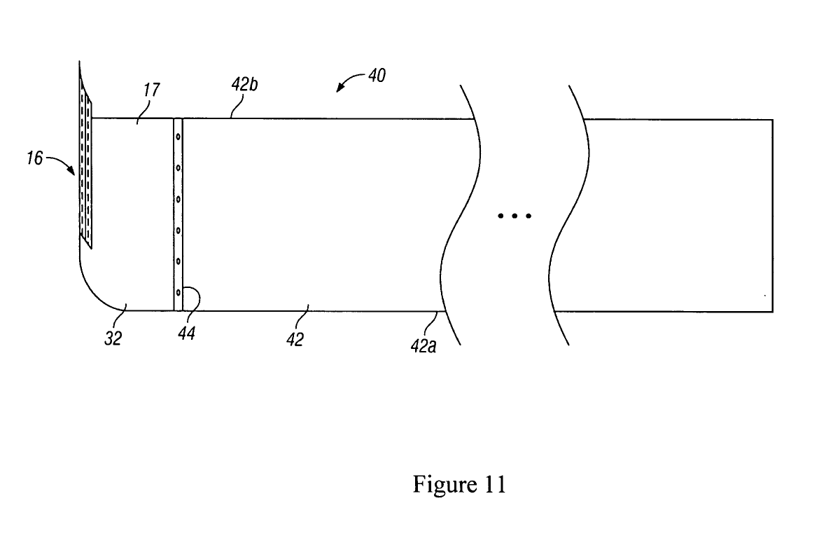

Referring to FIG. 11, a third embodiment of the invention provides an aerofoil 40 comprising a body 42 having a leading edge 42a and a trailing edge 42b. A fluid flow control device 17 as described in FIGS. 1 to 7 is provided at the distal end 44 of the aerofoil body 42. The same reference numbers are retained for corresponding features.

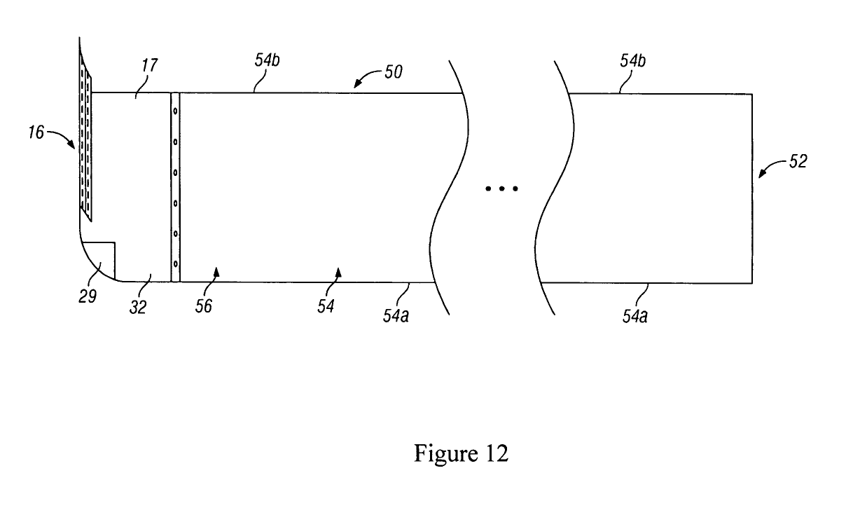

A fourth embodiment of the invention provides an aircraft wing 50, as shown in FIG. 12. The aircraft wing 50 comprises a root portion 52 for connection to the body of an aircraft (not shown), a central portion 54 comprising the main span of the wing 50, and a distal end portion 56. The central portion 54 has a leading edge 54a and a trailing edge 54b. A fluid flow control device 17 as described in FIGS. 1 to 7 is provided at the distal end of the distal end portion 56. The same reference numbers are retained for corresponding features.

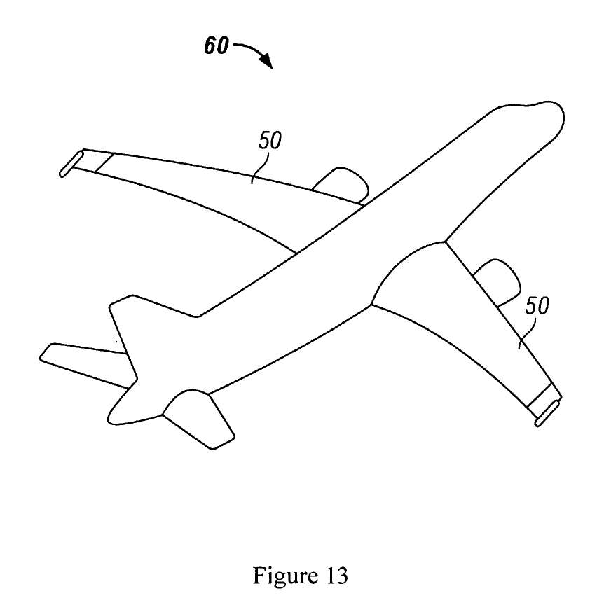

A fifth embodiment of the invention provides an aircraft 60, as shown in FIG. 13. The aircraft 60 comprises first and second aircraft wings 50 as shown in FIG. 12.

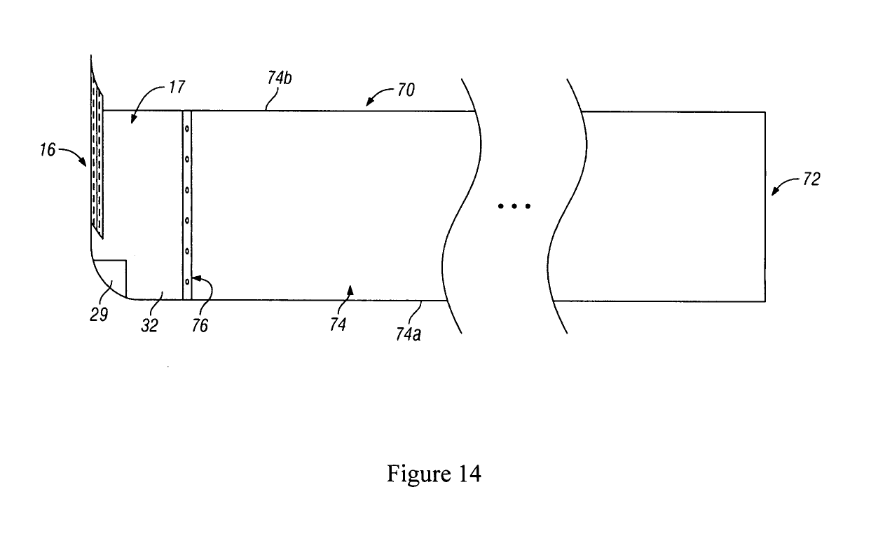

A sixth embodiment of the invention provides a turbine blade 70, as shown in FIG. 14. The turbine blade 70 comprises a root portion 72 for connection to a turbine body, a central portion 74 and a distal end portion 76. The central portion 74 forms the main span of the turbine blade 70 and has a leading edge 74a and a trailing edge 74b. A fluid flow control device 17 as shown in FIGS. 2 to 7 is provided at the distal end of the distal end portion 76. The same reference numbers are retained for corresponding features.

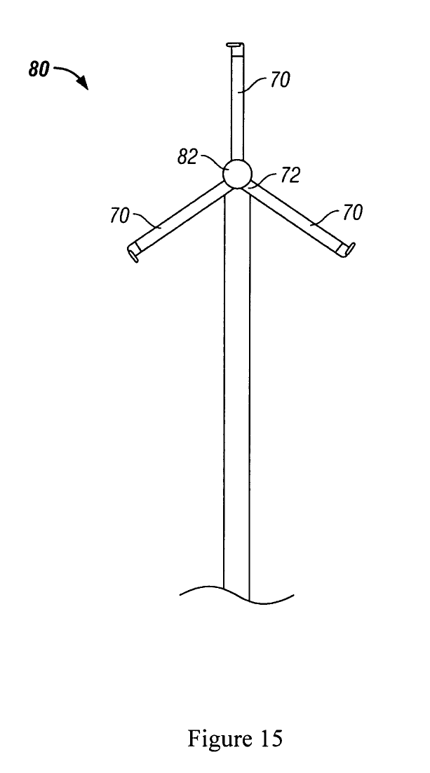

A seventh embodiment of the invention provides a wind turbine 80, as shown in FIG. 15. The wind turbine 80 comprises three turbine blades 70 as shown in FIG. 14. Each turbine blade 70 is connected via its root portion 72 to a turbine body 82. X

It will be apparent to those skilled in the art that various modifications and variations can be made to the present disclosure without departing from the spirit and scope of the disclosure. Thus it is intended that the present disclosure cover the modifications and variations of this disclosure provided they come within the scope of the appended claims and their equivalents.

What is claimed is:

1. A fluid flow control device for an aerofoil, the device comprising:
an aerofoil-tip body of aerofoil shape having a low pressure side and a high pressure side;
coupling apparatus adapted to couple one end of the aerofoil-tip body to a distal end of a aerofoil; and
a passive tip blowing assembly provided at the other end of the aerofoil-tip body, the assembly comprising a housing defining a fluid chamber and a vane of aerofoil shape provided within the fluid chamber, the fluid chamber extending along part of the chord-length of the aerofoil-tip body and having a fluid inlet at the high pressure side and a fluid outlet at the low pressure side, and the vane being arranged along the chord of the aerofoil-tip body and with its leading edge generally at the inlet and its trailing edge generally at the outlet, such that a fluid passage extending to the fluid outlet is defined on each side of the vane.

2. A fluid flow control device as claimed in claim 1, wherein the vane is of symmetrical faired aerofoil shape.

3. A fluid flow control device as claimed in claim 2, wherein the vane is of substantially the same aerofoil shape as the aerofoil-tip body.

4. A fluid flow control device as claimed in claim 1, wherein the vane is of substantially symmetric aerofoil shape and comprises a reduced-thickness section.

5. A fluid flow control device as claimed in claim 4, wherein the reduced-thickness section has a generally waisted sectional shape.

6. A fluid flow control device as claimed in claim 4, wherein the reduced-thickness section is provided between a first position on the vane chord located at generally one quarter along the chord length from the leading edge of the vane and a second position on the vane chord located generally 90 percent along the chord length from the leading edge, the camber of the vane at the first position being greater than the camber of the vane at the second position.

7. A fluid flow control device as claimed in claim 1, wherein the trailing edge of the vane extends beyond the fluid outlet.

8. A fluid flow control device as claimed in claim 7, wherein approximately 10% of the chord length of the vane at its trailing edge extends beyond the fluid outlet and the leading edge of the vane is located approximately at a position approximately 10% along the length of the fluid chamber from the fluid inlet.

9. A fluid flow control device as claimed in claim 9, wherein the fluid outlet is smaller than the fluid inlet such that the fluid chamber reduces in cross-sectional size along its length.

10. A fluid flow control device as claimed in claim 9, wherein the cross-sectional size of the fluid chamber reduces substantially linearly along its length by a ratio of 4:1.

11. A fluid flow control device as claimed claim 1, wherein the vane has a serrated leading edge.

12. A fluid flow control device as claimed in claim 1, wherein the housing comprises a concave shaped outer skin.

13. A fluid flow control device as claimed in claim 1, wherein the fluid inlet is generally trapezoidal in shape.

14. A fluid flow control device as claimed in claim 1, wherein the device further comprises a NACA scoop provided on the high pressure side of the aerofoil-tip body between the leading edge of the aerofoil-tip body and the fluid inlet.

15. A fluid flow control device as claimed in claim 1, wherein the aerofoil-tip body has an aerofoil shape which is different to the aerofoil shape of an aerofoil to which the fluid flow control device is to be coupled.

16. A fluid flow control device as claimed in claim 15, wherein the aerofoil-tip body has an aerofoil shape of a different upper camber to the upper camber of the aerofoil shape of an aerofoil to which the fluid flow control device is to be coupled.

17. A fluid flow control device as claimed in claim 16, wherein the aerofoil-tip body has an aerofoil shape of a higher upper camber to the upper camber of the aerofoil shape of an aerofoil to which the fluid flow control device is to be coupled.

18. An aerofoil comprising:
The fluid control device of claim 1; and
the aerofoil having a distal end, with the fluid flow control device being operably arranged at the distal end.

19. An aircraft wing comprising:
the fluid control device of claim 1;
a root portion for connection to the body of an aircraft;
a central portion;
a distal end portion; and
the fluid control device being operably arranged at the distal end of the distal end portion.

20. An aircraft comprising:
the fluid flow control device of claim 1;
an aircraft body;
an aircraft wing comprising a root portion configured to connect to the aircraft body, a central portion, and a distal end portion; and
the fluid flow control device being operably arranged at the distal end of the distal end portion.

21. A turbine blade comprising:
the fluid flow control device of claim 1;
a root portion configured to connect to a turbine body;
a central portion;
a distal end portion; and
the fluid flow control device being operably arranged at the distal end of the distal end portion.

22. A wind turbine comprising:
the fluid flow control device of claim 1;
a turbine blade comprising a root portion configured to connect to a turbine body, a central portion and a distal end portion; and
the fluid flow control device being operably arranged at the distal end of the distal end portion.
